(19) United States
(12) Patent Application Publication
(10) Pub. No.: US 2003/0172381 A1
(43) Pub. Date: Sep. 11, 2003

(54) Digital television system having personalized addressable content

(75) Inventor: Angel Janevski, New York City, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/056,363

(22) Filed: Jan. 25, 2002

(51) Int. Cl. H04N 5/445; G06F 13/00

(52) U.S. Cl. 725/46; 725/47

(57) ABSTRACT

A system and method for displaying to a user alternative content of a transmitted television program based on data stored in the user's profile as well as viewing context parameters, such as available viewing time or audience composition. Sources of alternative content to be presented include transmitted alternative program segments as well as media and Internet data input.

### BACKGROUND OF THE INVENTION

1. Field of the Invention

The present invention is directed to a digital television system which selects images for display to a user. In particular, the invention is directed to a digital television system which stores a profile for the user. Alternative content of television programs is then delivered to the user, based on the stored profile and additional input user parameters, such as available viewing time.

2. Description of Related Art

Heretofore, the range of video signal processing options available within a television receiver has been relatively limited. That is, in conventional television systems, most video signal processing is performed at the television station, as opposed to in the television receiver itself. This is particularly true in the case of inserting images, such as graphics, advertisements, etc., within a video sequence to be displayed by the television receiver.

More specifically, in conventional television systems, images are inserted into a video sequence at the television station, whereafter, the video sequence, including the inserted images, is transmitted to all television receivers within range of the station. With the advent of satellite broadcasting and cable television, however, inserting images at a single location, such as a television station, can have disadvantages, particularly with regard to television advertising. For example, television “superstations”, such as WGN of Chicago and WPIX of New York, are available in many cities in the U.S.; however, those stations contain local advertising which is specific to the city in which the station is located.

Systems have been developed to replace advertising segments to more appropriately address the locality of the viewer. An example of such a system is described in U.S. Pat. No. 6,160,570, issued Dec. 12, 2000 to Sitnik. Moreover, in Sitnik, a user profile is utilized to more effectively target the inserted replacement advertisement to an appropriate viewer demographic. By way of example, the user profile may contain information indicating that the user has children under the age of thirteen. Accordingly, in this case, the digital television system may select a toy advertisement, as opposed to an electronics advertisement, for display during a television program.

Such prior art systems can effect a simple replacement of one specific video segments for another when these segments are well defined, such as commercial spots. However, a need exists to permit a more sophisticated editing of the transmitted program. An example of such an editing feature is automatic deletion of one or more program segments to conform to viewing time constraints imposed by the user. This is best illustrated by a 60-minute news broadcast for which the user only wants to spend 20 minutes to view.

A further need exists in the prior art to perform such editing based on various viewing context parameters. By way of example, these include issues related to the viewing audience (e.g., the number of people in the room, the presence of small children, etc.) or to the viewing history (e.g., to thereby substitute a different advertiser's segment for one which the viewer has seen numerous times recently).

In addition, prior art systems are limited in how effectively they can perform personalization of program content. By way of example, prior art program recommender systems can be used to filter out movies, series or sports games not of interest to a viewer. However, these systems do not perform such filtering of segments of a program where the content is mixed in nature. In news, for example, it is the normal objective to deliver local, national, and international stories. Even with this basic separation, the consumer may have additional preferences. For example, a visitor to a city may not be interested in the local news. A visitor from abroad would definitely like to hear the international portion with an accent on the news from his native country. Similarly, in the case of a time-constrained viewing, the news within each group would have to be ranked and only the most prominent stories for the consumer are to be delivered.

A need exists in the prior art to extend this editing function to many types of programs such as sports, talk shows (to permit watching of only segments) or even movies (to permit watching compressed or substituted segments for those that the user may find objectionable).

### SUMMARY OF THE INVENTION

It is an object of the present invention to provide a method and apparatus for editing of a broadcast program in light of data contained in a user's personal profile and/or in light of the user's viewing context. This editing function comprises deletion and or replacement of segments of the originally broadcast program.

A more complete understanding of the present invention, as well as further features and advantages of the present invention, will be obtained by reference to the following detailed description and drawings.

### BRIEF DESCRIPTION OF THE DRAWINGS

FIG. 1 shows a prior art digital television system in which the present invention may be implemented;

FIG. 2 shows a block diagram of the digital television receiver shown in FIG. 1 incorporated into an embodiment of the present invention, and;

FIG. 3 is a flowchart depicting operation of the digital television receiver of an embodiment of the present invention;

### DETAILED DESCRIPTION

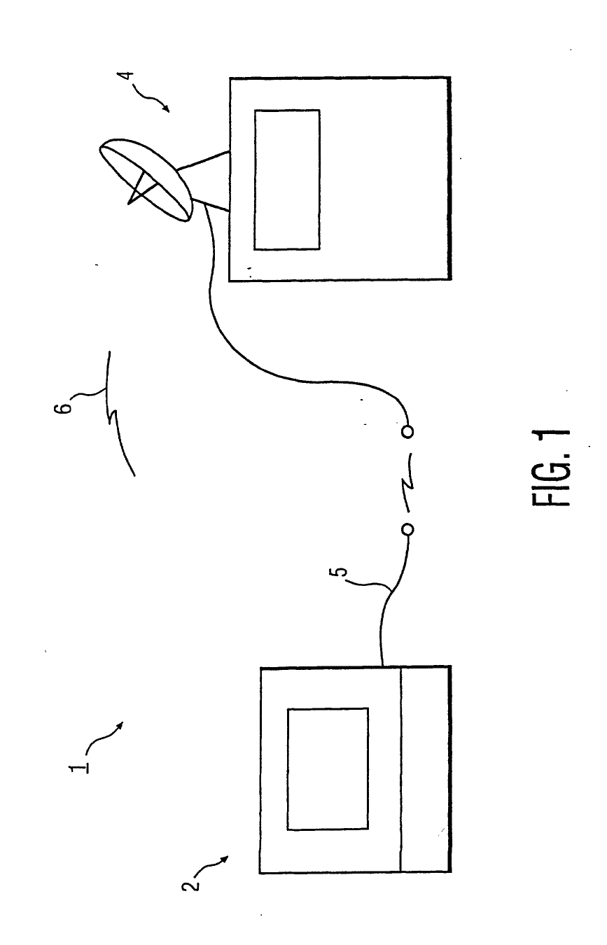

In one embodiment of the present invention a digital television system (i.e., a digital television receiver or a digital television receiver in combination with a set-top box) stores a user profile containing information concerning the user, such as the user's sex, age, preferences, location, etc. One such system is illustrated in FIG. 1 and described in U.S. Pat. No. 6,160,570 (Sitnik). In particular FIG. 1 shows an example of a television transmission system in which the present invention may be implemented. As shown in FIG. 1, television system 1 includes a digital television receiver 2, transmitter 4, and a transmission medium 5. The transmission medium 5 may be a coaxial cable, fiber-optic cable, or the like, over which video and audio data may be transmitted between the transmitter 4 and the digital television receiver 2. As shown in FIG. 1, the transmission medium 5 may include a radio frequency (hereinafter “RF”) link, or the like, between portions thereof. In addition, data may be transmitted between the transmitter 4 and the digital television receiver 2 solely via an RF link, such as RF link 6.

The transmitter 4 is located at a centralized facility, such as a television station or studio, from which an original television program (comprising one or more television shows and interspersed advertising segments) is transmitted to a users' digital television receiver. Such a television program consists of video and audio data. In preferred embodiments of the invention this video and audio data is coded, preferably at the centralized facility, prior to transmissions A preferred coding method for the audio data is AC3 coding. A preferred coding method for the video data is Motion Picture Experts Group (hereinafter “MPEG”) coding, and, in particular, MPEG-2 coding. It should be noted, however, that the invention can be implemented using other coding methods, such as DVB or the like.

The video data comprises a video sequence of the transmitted television program, while the audio data comprises sound associated with corresponding portions of the video data. In accordance with one embodiment of the invention described below, the data transmitted from the transmitter 4 may include video signals comprising at least two (i.e., two or more) alternative images which may be selected for display on the digital television receiver 2, together with corresponding audio data, if any. In further embodiments of the invention, identification data is transmitted together with each of the alternative images (and audio data) so as to identify the images as such, together with other information that is used during the image selection process described below.

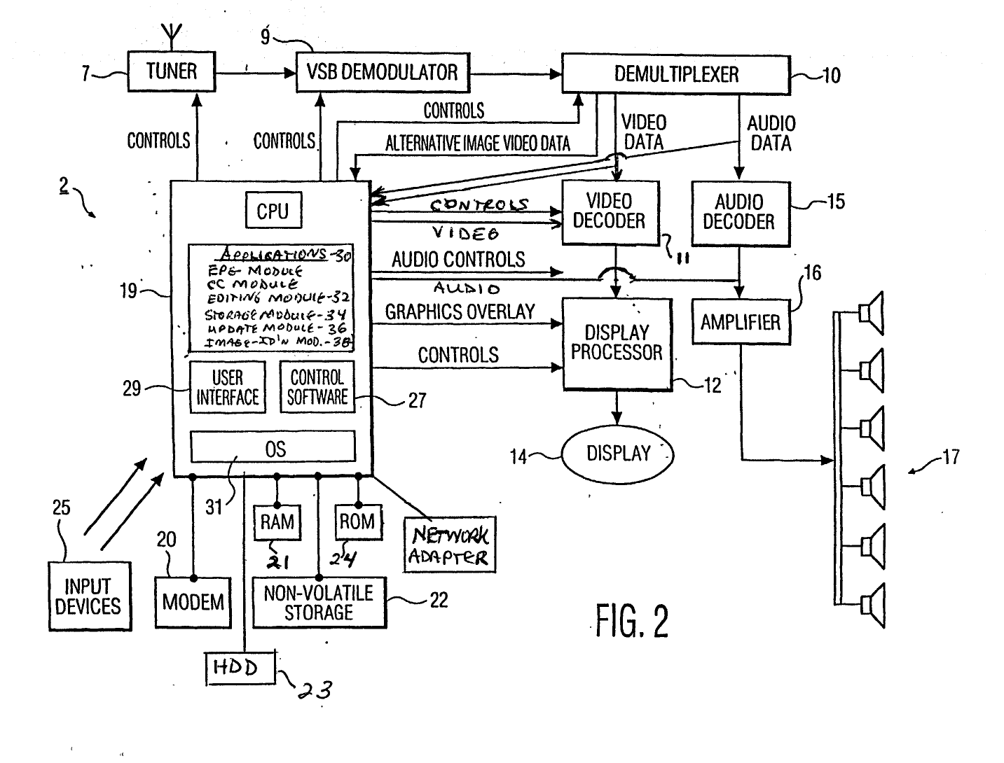

FIG. 2 is illustrative of shows a block diagram of a typical digital television receiver 2, augmented by features of the present invention. As shown in the figure, the digital television receiver 2 includes a tuner 7, a VSB demodulator 9, a demultiplexer 10, a video decoder 11, a display processor 12, a display screen 14, an audio decoder 15, an amplifier 16, speakers 17, a central processing unit (hereinafter “CPU”) 19, a modem 20, a random access memory (hereinafter “RAM”) 21, a non-volatile storage 22, a read-only memory (hereinafter “ROM”) 24, and input devices 25. Each of these features of the digital television receiver 2 is well known to those of ordinary skill in the art; however, descriptions thereof are nevertheless provided herein for the sake of completeness.

In this regard, the tuner 7 comprises a standard analog RF receiving device which is capable of receiving an analog signal that includes the video and audio data described above. Specifically, the tuner 7 receives this signal from either the transmission medium 5 or via the RF link 6 over a particular frequency channel. Which channel the tuner 7 receives the signal on, is dependent upon control data received from the CPU 19. This control data is based on data input via one or more of the input devices 25. In this regard, the input devices 25 can comprise any type of well-known television input device, such as a remote control, a keyboard, a knob, a joystick, etc.

The demodulator 9 receives the input analog signal from the tuner 7 and, based on control signals received from the CPU 19, converts the analog signal into digital data packets. It should be noted at this point that the invention is not limited to digital packets received from such a single tuner (which tuner is receiving the original program content). Alternative sources of data packets include, but are not limited to, the Internet, a dedicated service, media input device(s) (e.g. a DVD player), or one or more additional tuners.

These data packets are then output to the demultiplexer 10, preferably at a high speed, such as 20 megabits per second. The demultiplexer 10 receives the data packets output from the demodulator 9 and “desamples” the data packets, meaning that the packets are output either to the video decoder 11, the audio decoder 15, or the CPU 19 depending upon an identified type of the packet. Specifically, the CPU 19 identifies whether data packets from the demultiplexer 10 include video data, audio data, or “alternative image” video data based on identification data stored in those packets, and causes the data packets to be output accordingly. That is, video data packets are output to the video decoder 11, audio data packets are output to the audio decoder 15, and alternative image data packets (i.e., data packets containing video data for the alternative images described above) are output to the CPU 19. As depicted in FIG. 2 the originally transmitted program data is also output to CPU 19 and stored in a memory device such as a hard disk drive 23 (HDD).

In an alternative embodiment of the invention, the data packets are output from the demodulator 9 directly to the CPU 19. In this embodiment, the CPU 19 performs the tasks of the demultiplexer 10, thereby eliminating the need for the demultiplexer 10. Specifically, in this embodiment, the CPU 19, receives the data packets, desamples the data packets, and then outputs the data packets based on the type of data stored therein. That is, as was the case above, the originally transmitted television program is stored in HDD 23, video data packets are output to the video decoder 11, and audio data packets are output to the audio decoder 15. In this embodiment, however, the CPU 19 retains the alternative image data packets, rather than outputting those packets.

The video decoder 11 decodes video data packets received from the demultiplexer 10 (or from either the CPU 19 or from HDD 23) in accordance with control signals, such as timing signals and the like, received from the CPU 19. In preferred embodiments of the invention, the video decoder 11 is an MPEG-2 decoder; however, any decoder may be used so long as the decoder is compatible with the type of coding used to code the video data. The decoded video data is then transmitted to the display processor 12. Corresponding audio data is processed in a similar manner—as is well known in the art.

The display processor 12 can comprise a microprocessor, microcontroller, or the like, which is capable of forming images from video data and of outputting those images to the display screen 14. In operation, the display processor 12 outputs a video sequence in accordance with control signals received from the CPU 19 based on the decoded video data received from the video decoder 11 and based on graphics data received from the CPU 19. More specifically, the display processor 12 forms images from the decoded video data received from the video decoder 11 and from the graphics data received from the CPU 19, and inserts the images formed from the graphics data at appropriate points in the video sequence defined by the images formed from the decoded video data. With regard to the graphics data, the display processor 12 uses image attributes, chroma-keying methods and region-object substituting methods in order to include (i.e., to superimpose) the graphics data in the data stream for the video sequence.

The graphics data output by the CPU 19 may correspond to any number of alternative images transmitted to the CPU 19 in the alternative image data packets. That is, as described in more detail below, the CPU 19 selects one of the alternative images and then transmits the selected image to the display processor 12, together with control data including information as to when and where the selected image is to be displayed within a video sequence. This control data includes, but is not limited to, screen placement coordinates (e.g., where on a display screen the image is to be displayed), scaling and timing information for the image (e.g., the size of the image and times at which the image is to displayed), and presentation attributes (e.g., image color). In preferred embodiments of the invention, such control data is included in the data packet for each alternative image, and is merely transmitted by the CPU 19 to the display processor 12 following selection of an alternative image by the CPU 19.

The audio decoder 15 is used to decode audio data packets associated with video data (including alternative images) displayed on the display screen 14. In preferred embodiments of the invention the audio decoder 15 comprises an AC3 audio decoder; however, other types of audio decoders may be used in conjunction with the present invention depending, of course, on the type of coding used to code the audio data. As shown in FIG. 2, the audio decoder 15 operates in accordance with audio control signals received from the CPU 19. These audio control signals include timing information and the like, and may include information for selectively outputting the audio data, as described in more detail below. Output from the audio decoder 15 is provided to the amplifier 16. The amplifier 16 comprises a conventional audio amplifier which adjusts an output audio signal in accordance with audio control signals relating to volume or the like input via the input devices 25. Audio signals adjusted in this manner are then output via the speakers 17.

The CPU 19 comprises one or more microprocessors, which are capable of executing stored program instructions (i.e., process steps) to control operations of the digital television receiver 2. These program instructions comprise parts of software modules (described below) which are stored in either an internal memory of the CPU 19, ROM 24, or HDD 23 and which are executed out of the RAM 21. These software modules may be updated via the modem 20 and/or via the MPEG-2 bitstream. That is, the CPU 19 receives data from the modem 20, and/or via the MPEG-2, bitstream which may include, but is not limited to, software module updates, video data (e.g., graphics data or the like), audio data, and a user profile. A user profile comprises information relating to one or more viewers of the digital television receiver 2, and is used in the method for selecting one of the alternative images described below. The user profile may be stored anywhere within the digital television receiver 2, but, in one embodiment of the invention, the user profile is stored in the non-volatile storage 22. In this regard, the non-volatile storage 22 may comprise a-flash EPROM, NVRAM or the like, which is capable of being reprogrammed with, e.g., a new user profile, as desired. In addition, a high-volume storage device, e.g. hard disk drive 23 (HDD), is incorporated in the system, which in alternative embodiments could store user profiles.

At this point, it is noted that the invention may be implemented either (i) in a digital television system, such as that shown in FIG. 2, in which all control hardware is housed within the digital television receiver 2, or (ii) in a digital television system which includes both a digital television receiver and a set-top box. In the latter case, the CPU 19 above, or its substantial equivalent, may be housed in the set-top box, together with a memory that includes software modules executed thereby. In this case, the digital television receiver is controlled based on control signals from the set-top box, and will itself include one or more processors, such as the display processor 12 described above, for performing necessary control functions as well as video and audio display functions. In addition, for alternative embodiments described below, the system requires sufficient memory for recording of one or more received television programs and alternative content segments. This memory may comprise internal memory or an external device, such as a personal digital video recorder. Thus, although the invention can be implemented using different hardware configurations, for the sake of brevity, the following assumes that the hardware and software resides in the digital television receiver itself.

While the above discussion has primarily addressed processing of digital signals, the invention is not limited in this regard as it is envisioned that all aspects of the system can be achieved in the analog domain. By way of example, data packets can be embedded in the Vertical Blanking Interval (the “blank lines” of video picture between the bottom of one frame and the top of the next) similar to the well-known method of including closed caption text in line 21 of the Interval. Another example would comprise data packets being present in content received from the Internet.

FIG. 2 shows examples of software modules which are executable within the CPU 19. As shown in FIG. 2, these modules include a control module 27, a user interface module 29, application modules 30, and an operating system module 31. The operating system module 31 controls execution of the various software modules running in the CPU 19 and supports communication between these software modules. The operating system module 31 may also control data transfers between the CPU 19 and various other components of the digital television receiver 2, such as the ROM 24. The user interface module 29 receives and processes data received from the input devices 25, and causes the CPU 19 to output control signals in accordance therewith. To this end, the CPU 19 includes the control module 27, which outputs such control signals together with other control signals, such as those described above, for controlling operation of the various components of the digital television receiver 2. The CPU 19 may also execute software modules (not shown) to decode video and audio data received from the transmitter. In the case that the CPU 19 has this capability, the demulitplexer 10 provides the video and audio data packets noted above to the CPU 19 which performs the functions of the video decoder 11 and the audio decoder 15. In this case, the video decoder 11 and the audio decoder 15 can be removed from the invention.

The application modules 30 comprise software modules for implementing various signal processing features available on the digital television receiver 2. The application modules 30 can include both manufacturer-installed applications, i.e., “built-in” applications, and applications which are downloaded via the modem 20 or, alternatively, in the video data stream. Examples of well-known applications that may be included in the digital television receiver 2 are an electronic program guide (“EPG”) module and a closed-captioning (“CC”) module.

In an embodiment of the present invention, the application modules 30 comprise a storage management module 34 which receives the entire originally transmitted television program (or at least the segments selected for presentation) and stores them in the HDD 23. This module would also perform the functions of retrieval of program content, cross-relation of segments with their alternatives, and deletion of obsolete segments.

In a further embodiment of the invention, the application modules 30 would also comprise an update manager module 36 which analyzes received segments and matches the information about them with stored content. Further, it updates the stored segments with additional pointers to the newly received alternative segments. Based on the segment descriptions this module is capable of then requesting content from a service (e.g. the Internet) and processing the retrieved segments in the same way as if they were received through broadcast. Still further, this module is capable of scheduling “recordings” on broadcast channels that deliver segment updates.

In the present invention, the application modules 30 also include an editing module 32 which may be either a built-in or downloaded software module. In brief, the editing module 32 receives or compiles a user profile for the digital television receiver 2, stores that profile in a memory, such as the non-volatile storage 22, selects one of the alternative images provided to the CPU 19 by the demultiplexer 10, and causes the display processor 12 to display the selected alternative image within a video sequence (e.g., a television program) output to the display screen 14. The editing module 32 also controls the output of audio information, if any, that corresponds to the selected alternative image.

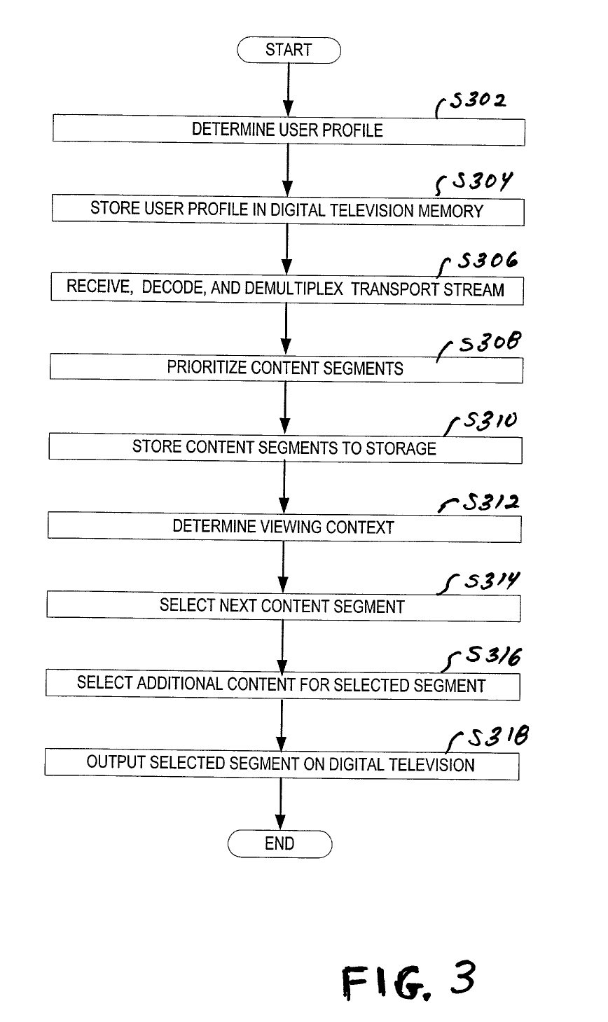

FIG. 3 shows, in detail, processing performed by the editing module 32. More specifically, in step S302, the editing module 32 determines a user profile for the digital television receiver 2. In this regard, as noted above, the user profile comprises information specific to the digital television receiver 2 which is used in the selection of one of the alternative images. Information in the user profile may include a user's television viewing habits, such as which television programs that the user watches regularly, times of day that the user watches television, and commercials “zapped” (i.e., switched off); generic information, such as the user's zip code, telephone area code, neighborhood, and country; and user demographic information, such as the user's age, sex, yearly income, personal preferences, and personal habits. Any combination of the foregoing or any other relevant information may also be included within a user profile. In some embodiments of the invention, different user profiles may be included in the digital television receiver for different viewers. In these embodiments, the appropriate user profile may be selected by, e.g., inputting a code corresponding to a particular viewer when the digital television receiver 2 is turned on. For simplicity's sake, however, the invention described herein will assume one user profile for the digital television receiver 2.

In the present invention, the user profile may be determined in one or more different ways. For example, a viewer may fill out an on-screen questionnaire using an input device. The user profile may then be based upon the answers provided in the questionnaire. Alternatively, the user profile may be determined at an external location, i.e., outside of the digital television receiver 2, and then downloaded to the digital television receiver 2 via the modem 20. As still another alternative, the digital television receiver 2 may itself compile the user profile. Specifically, the CPU 19 may do this by monitoring programming displayed on the digital television receiver 2 over a predetermined period of time (e.g., one month) and, based thereon, determine a user's viewing habits, preferences, etc. Such information may then be stored as the user profile for digital television 2. Combinations of the foregoing methods may also be used to determine the user profile. For example, a user may manually edit a profile determined automatically by the CPU 19; the user may request that the digital television receiver “fill in” missing answers of a questionnaire; etc.

Following step S302, processing proceeds to step S304, in which the user profile is stored in a memory, such as the non-volatile storage 22. In alternative embodiments the user profile would be retrieved from the HDD 23 and stored in RAM 21. In one embodiment of the present invention, step S306 then receives, from the demultiplexer 10, data packets containing a stream of transmitted image segments for display within a video sequence, and decodes video data in these packets if necessary. Next, step S308 prioritizes these segments and then, step S310 stores these content segments.

The viewing context is then determined in step S312. Using this determination in combination with the user profile, the system at step S314 then selects the next content segment to be outputted. In a further embodiment of the invention, at step S316 the system then determines if the selected segment is required to be augmented with additional content segments and selects those additional segments. Next, step S318 outputs the selected segment(s) to the digital television to be viewed by the user.

The present invention is not limited to situations in which the transmitted data packets contain the information necessary to correlate the corresponding alternative image segment with the user's profile. Additional embodiments of the invention address situations where the alternative images are stored for later presentation (this will be further addressed below). Well-known prior art systems are capable of analyzing such video images to perform identification of its content. An example of such prior art is an article by Dimitrova, et al. entitled “On Selective Video Content Analysis and Filtering (Proc. of SPIE Storage and Retrieval for Image and Video Databases VIII, San Jose, Jan. 26-28, 2000). Thus identified, a video segment packet can be annotated by the present invention thus providing selecting information where none was originally transmitted. Additional embodiments contemplate augmenting the packet information with such identified data even if packet descriptive data was originally provided.

In this embodiment the data that is received by S306 can be described as multiple content streams of annotated segments multiplexed as a single transport stream. Table 1 illustrates such a transport stream having four multiplexed (sub)streams:

TABLE 1

| | | | | |
|---|---|---|---|---|
| 5b | 4d | 3d | 2d | 1d |
| 5c | 4c | 3c | 2c | 1c |
| 5b | 4b | 3b | 2b | 1b |
| 5a | 4a | 3a | 2a | 1a |

In general, where, for a program time slot, we define the following: r=number of segments received (numbered as 1, 2, 3, 4, 5, . . . in the above example in Table 1), p=number of segments presented, h=number of multiplexed content streams (4 in this example). The collections of blocks annotated by integer numbers are called segments. Each segment has alternative content annotated by adding a letter to the integer. Two different modes of presentation will now be addressed with the aid of this model:

streaming mode

composition mode

Streaming Mode

In this mode, the system performs a relatively simple operation, such as that described in Sitnik, where one advertisement may be replaced for another. That is, by way of example, the originally transmitted television program comprises a data stream where alternative segments are transmitted as illustrated above in Table 1. For each segment, based on certain criteria, the system will choose only one of the alternatives for presentation that way dropping the rest of the alternatives. In this mode, p=r regardless of h.

An example presentation stream generated in this mode could be:

| | | | | |
|---|---|---|---|---|
| 5d | 4b | 3b | 2d | 1c |

This mode can be enhanced while still keeping the general streaming mode of operation unchanged. The content made out of a combination of selected segments can be stored in memory for delayed presentation (as in buffered play in personal video recorders). Storing of the transport stream permits greater flexibility in editing the program content presented to the user. That is, as this stream is still a concatenation of annotated segments, the annotation can be used later for further improvement of the content. Several examples of this feature are:

dropped segments are also saved and at a later presentation time, some of them could still be used. For example, if segment 1c was time-sensitive news story, perhaps few days later, it could be replaced with 1a, a story that can still be of interest to the viewer. Another good example is content stored based on personalization of one of the parents, but later on, when the saved stream is played back by one of the children, some graphical segments could be replaced by ones that are more appropriate.

only selected segment alternatives are saved, but additional alternatives can be delivered to the system later by means of regular TV, or other means such as Internet. For example, in this scenario, time-sensitive segments can be replaced by the alternatives obtained at later time. Example segments are commercials, news stories or even a different-angle shot of a soap opera segment demanded (or even ordered for money) by the viewer. All examples may also bring additional value to the content broadcasted earlier.

Similarly to the above there would be a stream where h=1, but the content is still annotated for later segment exchange. An example of this is a movie that is saved on a personal digital recorder and the viewer will get different commercials (and even alternative—angle shots) after or in parallel to the viewing. By way of example, this would be applicable to pay-per-view movie delivery where some of the content is pre-recorded overnight or some time before the presentation.

Composition Mode

In this mode, the system has resources to take into account all alternatives of each segment. Essentially, this is also a different paradigm of broadcasting than the streaming modes described above. In streaming, the broadcaster assumes that there is one alternative of each segment that will fit best. In this case, the broadcaster/content creator packages the content in two dimensions rather then in one, and the mode of operation is 0≦p≦h·r.

One packaging scheme with implicit prioritization of segments is illustrated in Table 2 below:

TABLE 2

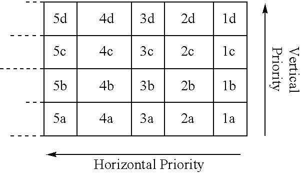

By way of example, the broadcaster/content creator may package the content in a scheme where earlier segments are more important than later segments and alternatives are also prioritized in a similar fashion. A simple example of this would be a news program where the “top news story” is presented first. Other ways of implicit prioritizing are possible where for instance, the user profile may indicate a preference for local news, or for a particular newscaster. In addition, the stream may also contain explicit prioritizing where the priority is embedded in the description of the segment or the time slot.

Simple Composition

A simple example of utilization of explicit/implicit prioritization is a news program where there are I number of international, D number of domestic, L number of local and E number of entertainment news stories. In one embodiment of the invention, the user is permitted to specify, for example, that they are interested in say 60% domestic, 20% international, 15% local, and 5% entertainment news. Knowing the priority for each news category, the system can decide how many additional segments to present to the viewer.

Furthermore, an additional embodiment of the invention determines the prioritization base on context-sensitive criteria. For example, on a weekday morning, the user does not have too much time and needs more accent on the local stories, so the system would only present one of each segment (as it is streamed) until it gets to the local segments when perhaps all of them (e.g., weather, traffic, etc) can be presented. However, in the evening, the user may have more time to catch up with the news, so the system can put more emphasis on domestic and international news.

In an additional embodiment of the invention, the above described composition mode framework can be used in insert information from other sources outside of the broadcast transport stream. Context components such as a link to the user's calendar, Internet information, and Electronic Programming Guides can be presented to the user in concert with desired program segments. The storing of program data in this embodiment of the invention enables this flexibility of the ultimate viewing agenda presented to the user. This timing feature has additional applications as well. By way of example, if the system knows that the user has an appointment or a sports game match on TV in 20 minutes, it can shrink the news program being viewed to 18 minutes.

An additional feature of the present invention is that some segments can be “promoted” in presentation due to significant priority assigned to them. For example, assume the system had initially determined for one reason or another to present the content from the stream above in the following order:

1a, 1c, 3b, 3c, 3d, 4a, 4b, . . .

Assume also that this is being presented to the user in essentially real time. Further assume, as the system is about to finish playing segment 3b, the reception of segment 5 began. The system learns that segment 5a contains breaking news (weather alert for example). Instead of placing 5a at the end of the play list, the system changes the play list to:

1a, 1c, 3b, 5a, 3c, 3d, 4a, 4b, . . .

and the user will still get to see the alert (almost) in real-time. Furthermore, if an even higher priority had been assigned and a story such as 5a was supposed to break any broadcast, than 3b's playback could have been even interrupted.

### ILLUSTRATIVE COMPOSITION EXAMPLE

In this example, segments are prioritized before broadcast, but the system also prioritizes the segments based on certain criteria. That is, the system could preserve the implicit prioritization scheme of Table 2, by aligning all segments and then selecting which to show to the user based on some criteria. The diagram below shows how this could be done.

The open circles mark segments that are for presentation while the black-filled circles mark segments to be dropped from presentation.

TABLE 3

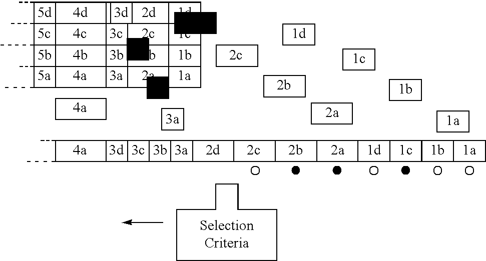

Alternative Segment Content

In addition to audio/video alternative segments, a further embodiment of the present invention utilizes segment alternatives as layers or enhancements of the content. For example, instead of offering an alternative presentation of the same content, the alternatives can contain enhanced content. A simple example would be a transport stream where alternative “b” is a ticker tape that can overlay the content in the alternative “a” segment. Furthermore, alternative “c” could be content that can be displayed in a picture-in-picture over the content of alternative “a” (for example, additional footage for a news story).

Alternative content can also be videotext, graphics, data (e.g., text related to the content) or even a pointer to external content source (e.g. a Web site) that can provide additional information regarding the content. The segment content can also be applications (e.g. Java object files) that are executed to enhance the content or enable user interaction.

Successful presentation of the alternative content may also depend on the system characteristics (e.g. screen size, available memory and storage space, processing power, fast Internet connection). In this case, the selection criteria may include the system state to select segment alternatives for presentation.

In additional embodiments of the invention, all or part of, the editing functions described above are selectable by the user. Thus, for example, a news program viewed tonight (and perhaps edited based on context-sensitive or user profile criteria) could then be stored and viewed at a later date without any further editing functions being performed by the system at the time of the second viewing. Further, these functions performed by the system can also be part of a service where the users of different service levels have access to different segment alternatives.

Clearly, use of such content layers and content enhancements have many alternative presentations due to context-sensitive criteria used in conjunction with time-delayed presentation of stored content. The present invention has been described with respect to particular illustrative examples. It is to be understood that the invention is not limited to the above-described embodiment and modifications thereto, and that various changes and modifications may be made by those of ordinary skill in the art without departing from the spirit and scope of the appended claims.

What is claimed is:

1. An apparatus for receiving a television program transmitted as a transport stream and for editing said television program for a user, said apparatus comprising:
a memory for storing said transport stream, a user profile and computer-executable process modules;
a display processor for receiving video data contained in said transport stream, and for providing the video data as a sequence of video segments;
a display for displaying the sequence of video segments; and,
an editing process module for producing an edited version of said television program in light of the user profile to thereby cause the display processor to display said edited version.

2. The apparatus of claim 1, wherein the editing process module produces an edited version in light of a viewing context of the user.

3. The apparatus of claim 2 wherein the viewing context of the user is selected from the group consisting of viewing-time constraints, composition of viewing audience, and user's viewing history with respect to said video segments of the television program.

4. The apparatus of claim 2 wherein the edited version of said television program comprises at least one video segment having been deleted.

5. The apparatus of claim 2 wherein the edited version of said television program comprises at least one video segment having been re-arranged in time.

6. The apparatus of claim 2 wherein the edited version of said television program comprises at least one additional video segment having been added.

7. The apparatus of claim 6 wherein said at least one additional video segment is supplied to the apparatus as an alternative segment transmitted in the transport stream.

8. The apparatus of claim 6 wherein said at least one additional video segment is supplied to the apparatus from at least one source separate from the transport stream.

9. The apparatus of claim 8 wherein said source is selected from the group consisting of one or more additional tuners, one or more media devices, a dedicated service and the Internet.

10. The apparatus of claim 2 wherein the editing process module utilizes video segment data.

11. The apparatus of claim 10 wherein the video segment data is present in the transport stream.

12. The apparatus of claim 10 wherein the video segment data is determined by an image-identification process module.

13. A data storage medium comprising indicia of instruction for a processor to perform a method for receiving a television program transmitted as a transport stream and for editing said television program for a user, said method comprises the steps of:
storing said transport stream and a user profile;
receiving video data contained in said transport stream;
providing the video data as a sequence of video segments; and,
producing an edited version of said television program in light of the user profile.

14. The method of claim 13 wherein the step of producing an edited version comprises utilizing a viewing context of the user.

15. The method of claim 13 wherein the step of producing an edited version comprises adding at least one additional video segment to the sequence of video segments.

16. The method of claim 13 wherein the step of producing an edited version comprises utilizing video segment data.

17. A method for receiving a television program transmitted as a transport stream and for editing said television program for a user, said method comprising the steps of:
storing said transport stream, a user profile and computer-executable process modules;
receiving video data contained in said transport stream;
providing the video data as a sequence of video segments;
displaying the sequence of video segments;
producing an edited version of said television program in light of the user profile; and,
displaying said edited version.

18. The method of claim 17 wherein the step of producing an edited version comprises utilizing a viewing context of the user.

19. The method of claim 17 wherein the step of producing an edited version comprises adding at least one additional video segment to the sequence of video segments.

20. The method of claim 17 wherein the step of producing an edited version comprises utilizing video segment data.
